(19) United States
(12) Patent Application Publication
(10) Pub. No.: US 2010/0145243 A1
(43) Pub. Date: Jun. 10, 2010

(54) METHOD AND MASSAGE DEVICE FOR STIMULATING ACTIVE POINTS LOCATED ON A HUMAN BACK

(76) Inventor: Alexander KANTOR, Jerusalem (IL)

Correspondence Address: HOUSTON ELISEEVA, 4 MILITIA DRIVE, SUITE 4, LEXINGTON, MA, 02421, US

(21) Appl. No.: 12/703,293

(22) Filed: Feb. 10, 2010

Related U.S. Application Data
(63) Continuation of application No. PCT/IL2008/001122, filed on Aug. 14, 2008.

(30) Foreign Application Priority Data
Aug. 16, 2007 (IL) 185348

(51) Int. Cl. A61H 15/00

(52) U.S. Cl. 601/118

(57) ABSTRACT

A method and massage device for stimulating active points located on a back of a user. The massage device includes a hollow body that can be filled with a filler material and sealed is described. The hollow body is made of a material allowing elastic deformations of walls of the hollow body under applied pressure when the body is pressed against a human's back. The hollow body comprises a first pair and a second pair of projecting portions. The projecting portions are spaced apart from each other by a distance substantially equal to the distance separating the first lines of the bladder meridian and the second lines located on the left and right sides of a human body, respectively. The method includes filling the hollow body with a hot fluid in the amount sufficient to provide required elastic deformations of the walls of the hollow body under applied pressure when the hollow body is pressed against the user's back, sealing the hollow body, and then pressing the massage device against the user's back such that the first pair of projecting portions and the second pair of projecting portions are applied to predetermined regions on the first and second lines of the bladder meridian.

### RELATED APPLICATIONS

This application is a Continuation of International Application No. PCT/IL2008/001122 filed on Aug. 14, 2008, which claims priority to Israeli Patent Application No. 185348 filed on Aug. 16, 2007, both of which are incorporated herein by reference in their entirety.

### FIELD OF THE INVENTION

The present invention relates to the field of massage devices and methods, and more particularly, to a massage device for stimulation of various active points on the human body for physical therapy and healing.

### BACKGROUND OF THE INVENTION

The benefits of massage on the health of man have been known for many centuries. One of the types of massage therapy, referred to as acupressure, involves massage of biologically active points and localized morphological regions along the spinal column, neck and other sites on the human body. It is recognized by massage therapists, physical therapists and chiropractors that acupressure can augment the function of the internal organs of the body, and also provide relief to people suffering from back and neck pain, pain associated with stress, sport tension, etc.

According to the oriental medicine paradigm, the mechanism of acupressure is based on the presence of the natural energy Qi (pronounced “chi”) that flows throughout the body along meridians (or energy channels), each being related to a specific organ. In disease, the flow of Qi through a certain meridian is disrupted, and the organ that correlates to the meridian will not function properly. Stimulating certain active points distributed along the meridians helps to normalize impaired conditions.

On the other hand, western medical thinking suggests that the biologically active points are related to the nervous system of the organism. Thus, massage of the active points may stimulate the production and release of endorphins, which serve to reduce the sensation of pain and affect emotions.

It is known that the effect of acupressure therapy can be improved by heating the regions to which massage is applied, owing to the increase of the circulation of blood and energy. In addition, it may be necessary for pressure to be applied over a continued period of time. In this case, manual application of pressure is subject to shortcomings, especially when it is attempted by the patient himself, both because of difficulties in locating the appropriate pressure points, as well as the difficulties associated with the continuous maintenance of pressure on the points over an extended period of time.

Various pressure applying devices are known for continuous application of pressure to certain active points.

For example, U.S. Pat. No. 3,705,579 to Morini et al. describes a massage device permitting the user to massage his own back. The device is constituted by a kind of bobbin having a narrowed central portion and, symmetrically on each side of said portion, two bodies of revolution. The application of the self-massaging device is effected by the user himself who interposes it between his back and a flat surface. In operation, the user moves his back parallel to the flat surface in such manner as to cause the device to roll on itself while being maintained against the flat surface.

U.S. Pat. No. 3,750,654 to Shiu describes a roller of circular cross-section having a length approximately equal to the width of the back of a normal adult man or woman. The roller has two rounded, circumferential projections which are spaced apart by a distance such that when the roller is in contact with the back the projections may be located on opposite sides of the spine. In operation, the user places the roller against a surface and produces relative rolling movement between the roller and the body so that the projections course along the bladder meridians to stimulate the first lines of the meridian.

U.S. Pat. No. 4,374,519 to Stauft describes a spinal massage device comprising four rubber balls mounted in pairs on opposite sides of a linking plate in such a manner that the balls are rotated along a supporting surface, such as the floor, as the user lies with his spine on the device and then moves his back parallel to the floor.

U.S. Pat. No. 4,433,683 to McCoy, et al. describes a hand-held maniputable exercise-massage device which enables the user to use it as a rolling or massaging implement for reducing tension and relieving body aches and pains. The device comprises opposed spring-biased handle portions having mounted therebetween a plurality of roller members so that the user may distend the handles to obtain arm and hand exercising and may use the device for rolling action on the back of the neck or the like, to relieve tension, knotted muscles and, generally, impart a relaxing sensation to the user.

U.S. Pat. No. 4,712,539 to Kim describes a therapeutic device for applying pressure to various muscles and other parts of the body having a plurality of disc-shaped rolling elements rotatably mounted on a shaft and disposed between nonrotating handles. In one embodiment, a symetrically curved rolling element centrally disposed between smaller disc-shaped rolling elements is configured to apply pressure to muscles of the spine or neck, correspondingly.

U.S. Pat. No. 5,170,778 to Jamis describes a body pressure massaging device which permits a user to massage his back by placing the device between his back and a flat surface. The device comprises a threaded cylindrical dowel which is used to assemble a central narrow circular element having a shaped surface together with a pair of rounded end elements. The central narrow element has a hollow center with threads that mate with the threaded cylindrical dowel so that the central element may be mounted anywhere on the dowel. On each side of the central narrow element there is mounted on the dowel a rounded end element or bell shaped cap. The surface of each of the bell shaped caps has a raised bulbous ridge around the largest circumference of the cap. Each cap has a hollow cylindrical region with threads mating with the threads of the cylindrical member for mounting each cap a specific distance from the central narrow element. The back pressure massage device operates by placing the device on the floor with the user lying on the device and moving along the floor to rotate the device thus effecting a massaging of the back without injuring the spinal column.

U.S. Pat. No. 5,577,995 to Walker describes a therapeutic device to mobilize the spinal joints and soft tissues surrounding the human spine. The device includes two substantially solid spherical balls mounted on a shaft for independent rotation. In one embodiment, the balls have a spherical to elliptical configuration and comprise an inner ball portion of a variable density synthetic plastic material and with an outer covering or portion comprised of a flexible material. The balls have a confronting area forming a substantially elliptical shape extending from a major spherical ball portion. Another embodiment comprises two spherical rubber balls having an inner ball formed of hard material to assist in the mobilizing operation and an outer flexible rubber cover.

U.S. Pat. No. 5,577,996 to Gardner et al. describes a hand held massage device having a plurality of spheres adjustably mounted on an axial rod with enlarged grip handles mounted on the outer ends of the rod for rotation. The spheres of the massage device may be adjusted to various positions along the axis of the rod for comfort, so that the operator may direct the massage to specific areas.

U.S. Pat. No. 6,974,427 to Lapham describes a spinal and soft tissue mobilizer of modular construction for physical therapy. The device has an elongated generally spool-shaped roller with a reduced diameter mid portion and larger diameter teardrop-shaped outer end portions rollers that apply pressure to the thoracic vertebrae, rib cage and muscles of the back without directly contacting the vertebrae. The mid portion may have lateral rollers with laterally spaced larger diameter portions that straddle the vertebrae of the spine and apply pressure to the muscles surrounding the straddled vertebrae without directly contacting the vertebrae. An individual may use the device by placing the device on the floor underneath his/her back and moving back and forth over the device. Alternatively, an operator may grip the handles and roll the device up and down along the back and spinal area of an individual lying face down on a flat surface. The device may also be mounted horizontally in a doorway whereby the user can move his or her back up and down while at the same time applying a reasonably constant force against the device.

### SUMMARY OF THE INVENTION

Despite the known techniques in the area of massage devices that can be used for treatment of medical disorders of a human organism by stimulation of active points of the body, there is a need for a novel massage device designed to stimulate the circulation of blood and energy. Thus, it would be advantageous to have a massage device configured for stimulating active points located in predetermined morphological regions of the human body. It would also be advantageous that the massage device would have controllably variable rigidity and temperature, all the above features being present in a single package.

In addition, it would be advantageous to have a method for applying simultaneously a pressure and a predetermined temperature to predetermined morphological regions of the human body over a predetermined time period for treatment of a particular medical disorder of the human organism.

The present invention satisfies the aforementioned need by providing a novel massage device that includes a hollow body that can be filled with a filler material and sealed. The hollow body is made of a material allowing elastic deformations of walls of the hollow body under applied pressure when the body is pressed against a human's back. The hollow body can, for example, be sealed by a cap. When desired, the hollow body can be sealed by welding or by any other sealing technique.

The hollow body comprises a first pair of projecting portions connected by a central portion, a second pair of projecting portions connected to the projecting portions through connecting portions, and a neck portion connected to the projecting portions. The central portion has less cross-sectional dimension than the cross-sectional dimension of the projecting portions. The projecting portions are spaced apart from each other by a distance substantially equal to the distance separating the first line of the bladder meridian located on the left side of a human body and the first line of the bladder meridian located on the right side of the human body.

Each projecting portion of the second pair is disposed symmetrically with respect to the center of the central portion and extends axially outwardly from a respective one of the first pair of projecting portions. The second pair of projecting portions is spaced by a distance substantially equal to the distance separating the second line of the bladder meridian located on the left side of the human's back and the second line of the bladder meridian located on the right side of a human's back. The projecting portions of the first and second pairs have an axial dimension in the range of one to two dimensions of the active point located on a human's back.

The neck portion is axially extended outwardly from any one of projecting portions. The neck portion has an opening through which a filler material (such as a material, free-flowing dry material and/or fluid) can flow for filling and emptying the hollow body. The opening is configured to be opened and closed by the cap.

For example, the filler material can have temperature in the range of about 50° C. to about 70° C. The amount of the filler material filling the hollow body can be in the range of about 50% to about 100% of the volume of the hollow body.

The massage device of the present invention has many of the advantages of the prior art techniques, while simultaneously overcoming some of the disadvantages normally associated therewith.

The massage device according to the present invention can be applied simultaneously to first and second lines of the bladder meridian.

The massage device according to the present invention has controllably variable rigidity and temperature. The rigidity of the device can be adjusted by varying the amount of the fluid filled in the hollow body. The temperature of the device can be adjusted by varying the temperature of the fluid filled in the hollow body; thereby the massage effect can be freely controlled.

The massage device according to the present invention may be easily and efficiently manufactured, for example, by using a melting blow molding technique.

The massage device according to the present invention is of durable and reliable construction.

The massage device according to the present invention may have a low manufacturing cost.

The present invention also satisfies the aforementioned need by providing a supporting surface for use with the massage device of the present invention. According to one embodiment of the present invention, the supporting surface comprises a mat or board having dimensions sufficient for accommodation of the back of a typical adult human recumbent thereon. The mat or board comprises a planar under-surface to be supported on a flat surface, and an outer surface. The outer surface includes guiding elements configured for directional rolling said massage device along the outer surface.

According to another embodiment of the present invention, the supporting surface comprises a mat that includes two panels of an elastic material. The panels have dimensions sufficient for accommodation of the back of a typical adult human recumbent thereon. The two panels are bound together in such a manner that openings are formed for inserting said massage devices between the panels at the places which correspond to the predetermined regions of the user's back when the user lies on the mat.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 illustrates a plan view of a massage device, according to one embodiment of the invention;

FIG. 2 illustrates a plan view of a massage device, according to another embodiment of the invention;

FIG. 3 illustrates a rear view of a human being to relate the acupuncture bladder meridian to skeleton, and location of the massage device with respect to the active points along the meridian in use during physiotherapeutic treatment in accordance with an embodiment of the present invention;

FIG. 4A to 4E illustrates schematically consequence of locations of the massage device with respect to the human body in use during physiotherapeutic treatment in accordance with an embodiment of the present invention;

FIG. 5 is a partially broken top view of a supporting surface for the massage device shown in FIG. 1, in accordance with one embodiment of the present invention;

FIGS. 6A and 6B illustrate schematic side views of the supporting surface of FIG. 5, according to two different embodiments of the invention.

FIG. 7 illustrates a side view of a supporting surface for the massage device of the present invention, in accordance with another embodiment of the present invention;

FIG. 8 illustrates the manner of the use of the supporting surface shown in FIG. 7;

FIG. 9 illustrates a plan view of a massage device, according to still another embodiment of the invention;

FIG. 10 illustrates a planar view of a supporting arrangement for use with two or more massage devices of the present invention, in accordance with an embodiment of the present invention; and

FIG. 11 illustrates an example of a spacer elements used in the supporting arrangement shown in FIG. 10.

### DETAILED DESCRIPTION OF THE PREFERRED EMBODIMENTS

The principles and operation of a massage device according to the present invention may be better understood with reference to the accompanying description and the drawings, in which preferred embodiments of the invention are illustrated. It should be understood that these drawings are given for illustrative purposes only and are not meant to be limiting. The present invention may be embodied in many different forms and should not be construed as limited to the embodiments set forth herein. The same reference numerals and alphabetic characters will be utilized for identifying those components which are common in the massage device and its components shown in the drawings throughout the present description of the invention.

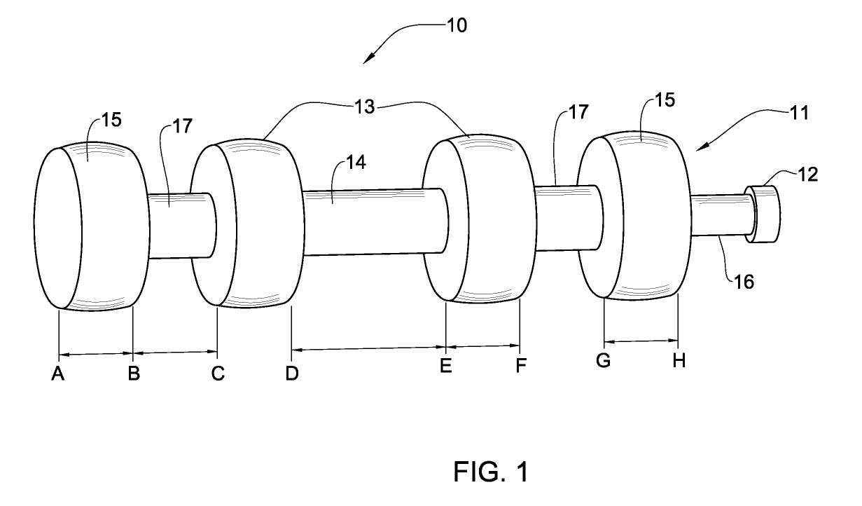

Referring to FIG. 1, a plan view of a massage device 10 for stimulating active points located on a back of a human (not shown) is illustrated, according to one embodiment of the invention. The massage device 10 includes a hollow body 11 and a cap 12. The hollow body 11 is made of a material allowing elastic deformations of walls of the hollow body under applied pressure when the body 11 is pressed against a human's back (not shown). The cap 12 is adapted for sealing the hollow body 11.

The hollow body 11 comprises a first pair of projecting portions 13 connected by a central portion 14, a second pair of projecting portions 15 connected to the projecting portions 13 through connecting portions 17, and a neck portion 16 connected to the projecting portions 15.

The central portion 14 has less cross-sectional dimension than the cross-sectional dimension of the projecting portions 13 and 15. In fact, the central portion 14 forms a clearance which does not touch the user's spinal column. The projecting portions 13 are spaced apart from each other by a distance substantially equal to the distance separating the first line (not shown) of the bladder meridian located on the left side of a human body and the first line (not shown) of the bladder meridian located on the right side of the human body.

Each projecting portion 15 of the second pair is disposed symmetrically with respect to the center of the central portion 14 and extends axially outwardly from a respective one of the first pair of projecting portions 13. The second pair of projecting portions is spaced by a distance substantially equal to the distance separating the second line (not shown) of the bladder meridian located on the left side of the human's back and the second line of the bladder meridian located on the right side of the human's back. The projecting portions 13 and 15 have an axial dimension in the range of one to two dimensions of the active point located on a human's back.

The neck portion 16 is axially extended outwardly from any one of projecting portions 15. The neck portion 16 has an opening (not shown) through which a fluid can flow for filling and emptying the hollow body 11. The opening is configured to be opened and closed by the cap 12. It should be appreciated that the neck portion 16 may be used as a hand that allows a user to hold the massage device 10 and/or move it with respect to the user's back.

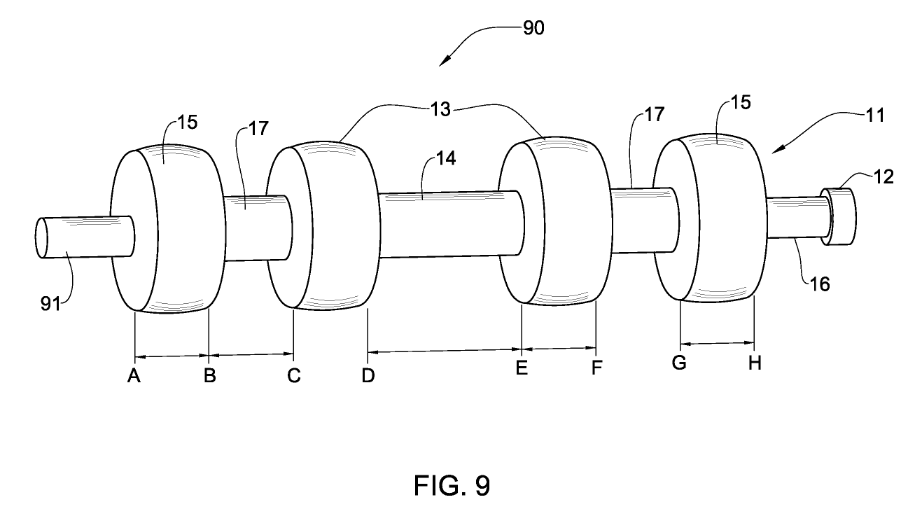

Referring to FIG. 9, a massage device 90 of the present invention is illustrated according to another embodiment of the present invention. The device 90 differs from the device 10 shown in FIG. 1 in the fact that the massage device 90 is equipped with another hand 91 connected to the projecting portions 15 symmetrically to the neck portion 16 from the other end of the hollow body 11 than the end of the neck portion 16. According to an embodiment of the present invention, such another hand can be a part of the hollow body 11. Alternatively, this hand can be a separate unit attached to the hollow body 11, for example, with the help of an adhesive material (glue).

According to the embodiments shown in FIGS. 1 and 9, the hollow body 11 has a substantially circular cross-section. An outer diameter of the hollow body 11 at the projecting portions 13 and 15 can be in the range of about 6 cm to about 10 cm, whereas an outer diameter of the hollow body 11 at the central portion 14 and connecting portions 17 can be in the range of about 3 cm to about 6 cm. An axial dimension D_{DE} of the central portion can be in the range of 5 cm to 9 cm. The axial dimensions D_{AB}, D_{CS}, D_{EF} and D_{GH} of the projecting portions 13 and 15 can be in the range of about 2 cm to about 3 cm. For each side of the hollow body with respect to the center of the central portion 14, axial distances D_{BC} and D_{FG} between the projection portion 13 and projection portion 15 can be in the range of about 2 cm to about 4 cm. The axial dimension of the neck portion 16, when it is used as a hand, and the axial dimension of the other hand 91 can, for example, be in the range of about 3 cm to about 10 cm.

The hollow body 11 is made of a thermoplastic polymer material. Examples of the polymer material include, but are not limited to, polyethylene, polypropylene, polyethylene terephthalate, and polyamides.

The hollow body 11 can be formed by blow-molding, injection molding or die-casting techniques. These techniques are known per se, and therefore will not be expounded hereinbelow.

The hollow body 11 has a thickness of the walls small enough to allow elastic deformation of the body 11 in the event when the massage device of the present invention is pressed against a human back, but great enough to maintain the structural integrity of the hollow body 11. Depending on the strength of the material, the thickness of the walls of the hollow body 11 can, for example, be in the range of 0.1 mm to 1 mm.

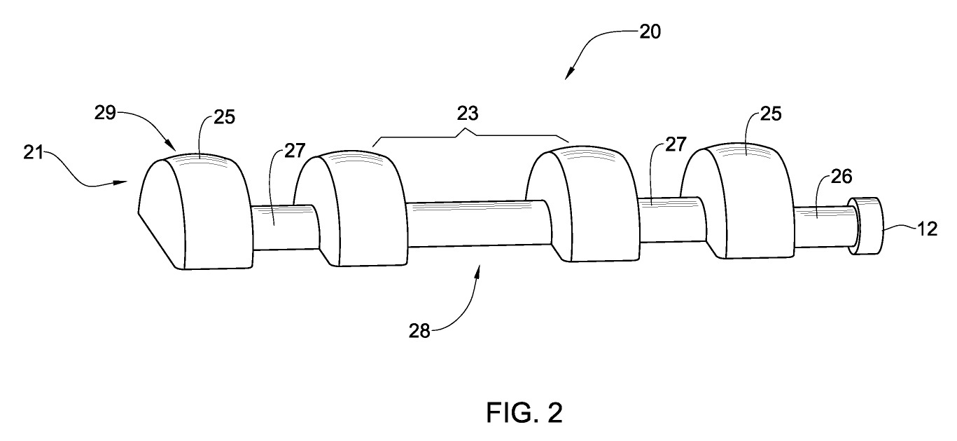

Referring to FIG. 2, a plan view of a portion of a massage device 20 for stimulating active points is illustrated, according to a further embodiment of the invention. A hollow body 21 of the massage device 20 differs from hollow body 11 of the massage device 10 in the fact that it has a substantially semicircular cross-section. Thus, the hollow body 21 has a substantially planar bottom surface or base 28 and arcuated walls 29. The corresponding projecting portions 23 and 25, central portion 24 and connecting portions 27 all have substantially semi-cylindrical shape. The neck portion 26 of the hollow body 21 is similar to the neck portion 16 shown in FIG. 1, and has a circular cross-section. The neck portion 26 is connected to any one of the projecting portions 25. The height of the semicircular cross-section from the base 28 to an apex of the arcuated walls 29 at the projecting portions 25 can be in the range of 3 to 5 cm. The height of the semicircular cross-section from the base 28 to the apex at the central portion 24 and the connecting portion 27 can be in the range of 2 cm to 3 cm.

When desired, the massage device 20 can further include a nonskid pad (not shown) attached to the base 18 which resists lateral slippage or skidding of the device when it is placed on a support surface (e.g., a floor or a specially provided board), and the user lies back down on the device. The nonskid pad can be formed of resilient material, e.g., a foam rubber, attached to the base 18 with an adhesive material.

When desired, the massage device 20 can be equipped with another hand (not shown) connected to the projecting portions 25 symmetrically to the neck portion 26 from the other end of the hollow body 21 than the end of the neck portion 26.

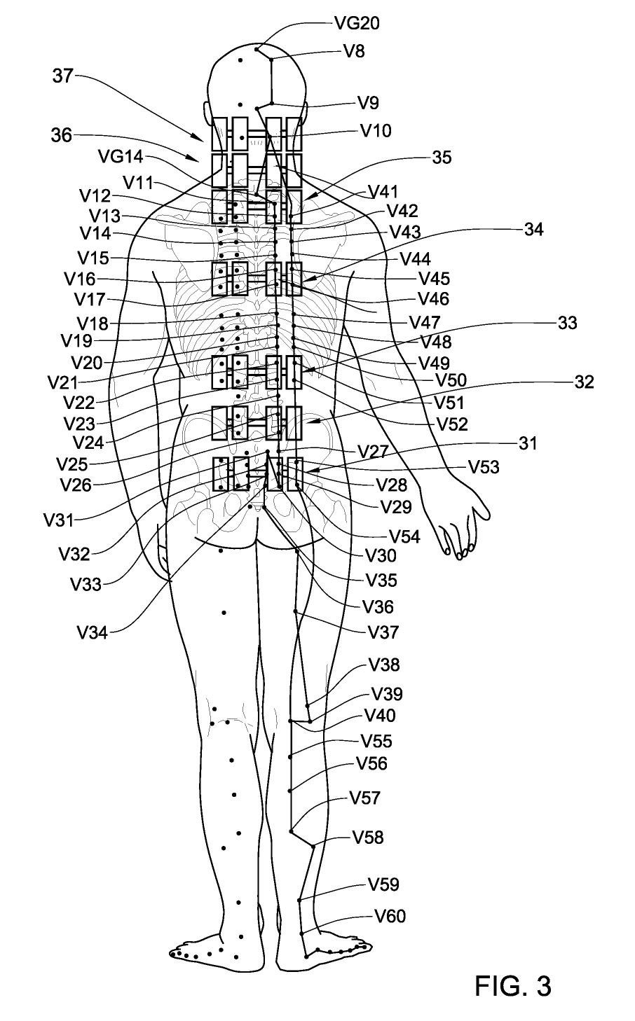

Referring to FIG. 3, a rear view of a human being to relate the acupuncture bladder meridian to a human skeleton is illustrated. In accordance with the teachings of oriental medicine, a bladder meridian BM, existing bilaterally, extends from the medial corner of each eye (not shown) upwards across the top of the head to descend along a respective side of the spine and one leg so as to terminate at the lateral aspect of the small toe. In the region of the neck, the bladder meridian BM divides into two channels, so as to form a first line BM1 and a second line BM2 somewhat further from the spine. The two lines BM1 and BM2 recombine in the region of the back of the knee. The bladder meridian BM is located on each side of the spine although for simplicity of illustration only that associated with one side is shown in FIG. 3. On the back, the first line BM1 is arranged at the distance of about 1.5 cun lateral to the spine, whereas the second line BM2 is arranged further from the spine, at the distance of about 3 cun lateral to the spine (herein, the cun is a traditional Chinese unit of measurement, approximately equal to 3.3 cm).

Spaced at intervals along the meridian are a number of biologically active points, stimulation of which has beneficial effects on the working of various internal organs.

A method of using the massage device of the present invention includes filling the hollow body (11 in FIGS. 1 and 9, and 21 in FIG. 2) with a hot filler material and sealing, for example, with the cap 12. When desired, the filler material can be heated being inside the hollow body. For this purpose the hollow body can be placed into a hot medium, for example into hot water. Likewise, a heating device, such as a microwave oven, can be used for heating the filler material.

According to another embodiment, a dedicated heating device, such as an electric heater, can be mounted within the hollow body and be configured for heating the filler material when its temperature is not high enough.

According to a further embodiment, the temperature of the filler material can be varied by adding a hot liquid into a granular material.

According to still a further embodiment, the temperature of the filler material can be varied by mixing two or more different materials that produce exothermic and/or endothermic reactions.

Examples of the filler material include, but are not limited to, fluid, granular materials and free-flowing dry materials.

Examples of the fluid include, but are not limited to, water, gelatin, oil, or other liquid. Examples of the granular materials and/or free-flowing dry materials include, but are not limited to, sand, dry granular salts (e.g., sodium chloride), etc.

Preferably, the temperature of the filler material can be in the range of about 50° C. to about 70° C., most preferably in the range of 55° C. to 65° C. The amount of the filler material filling the massage device can be in the range of about 50% to about 100% of the volume of the hollow body. It should be understood that if the volume of the filler material is less than 50% of the capacity, the rigidity becomes too small to provide a sufficient massaging effect. On the other hand, when the volume of the filler material is 100% of the capacity, the hollow body is hardly subjected to elastic deformation due to the lack of empty space. In this case, even though external force is applied to the hollow body, the body keeps its taut state.

In treatment, the massage device of the present invention, filled with a hot liquid as described above, is pressed against predetermined regions 31 through 37 on the back of a human (see FIG. 3) such that the projection portions (13 and 15 in FIG. 1, or 23 and 25 in FIG. 2) are applied to the first BM1 and second BM2 lines of the bladder meridian, correspondingly.

Specifically, the region 31 is located in the sacral region, at the level of the second, third and fourth posterior sacral foramina and includes active points V28, V29, V32, V33, V34, V53 and V54. The region 31 can be used to treat several disorders, including, inter alia, urinary problems, male deficiency related sexual problems, female sexual and reproductive disorders, low back pain, etc.

The region 32 is located on the lower back near the sacroiliac joint of a human, at the level of the spinous process of the fourth and fifth lumbar vertebrae, and includes active points V25 and V26. The region 32 can be used to treat, inter alia, back pain problems, disorders related to constipation and/or menstruation.

The region 33 is located on the lower back, at the level of the spinous process of the first and second lumbar vertebrae, and includes active points V22, V23, V51 and V52. The region 33 can be used to treat disorders of internal organs located in the vicinity of the region 33, such as liver, spleen, spleen-pancreas, stomach, small and large intestine.

The region 34 is located on the upper back, at the level of the spinous process of the fifth and sixth thoracic vertebrae, and includes the active points V15, V16, V44 and V45. The region 34 can be used to facilitate respiration, invigorate blood and treat cardiac and lung disorders.

The region 35 is located on the upper back, at the level of the spinous process of the seventh cervical and first thoracic vertebra, and includes active point V11 and VG14. The region 35 can be used to treat problems associated with shoulder, elbow and wrist joints, hand muscles and tendons, as well as cardiac and lung disorders.

The region 36 is located on the neck, at the level of the second and third cervical vertebrae. The region 36 can be used to treat problems associated with the gullet, pharynx and thyroid gland.

The region 37 is located in the nuchal region, at the level of the first and second cervical vertebrae. The region 37 includes active point V10 and can be used to treat disorders of eyes, ears and nose.

It should be noted the nomenclature utilized for identification of location of the regions 31-37 on the back of a human is used for convenience of mapping the back and does not limit generality of the description. There is no intention to be bound by any type of medical theory describing the therapeutic effect of massage provided by the device of the present invention.

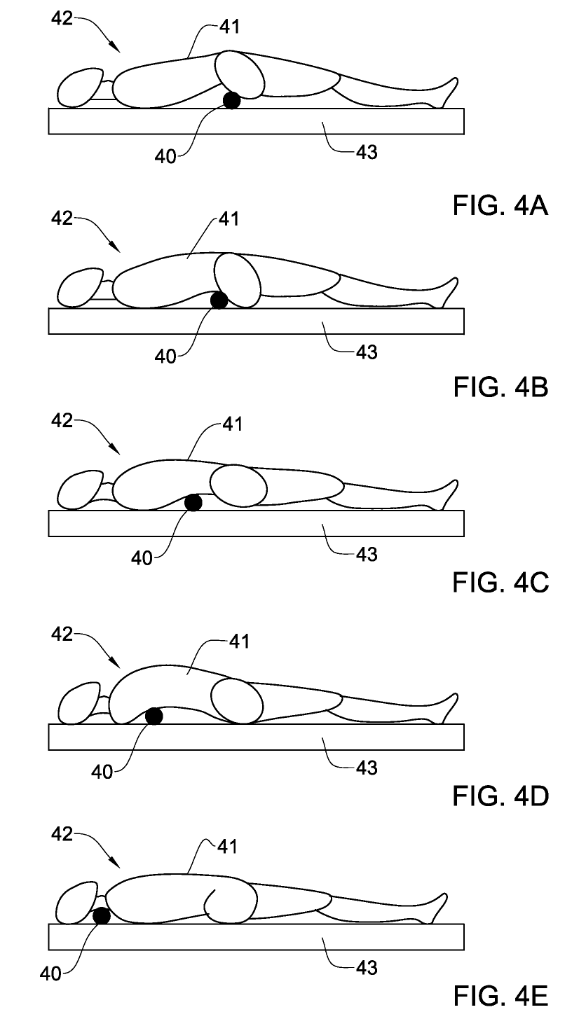

Referring to FIGS. 4A through 4E together, the massage device 40 of the present invention may be placed on a substantially flat rigid supporting surface 41 to be sandwiched between the supporting surface 41 and the back of a user 42 who is positioned supine to press his or her back against the massage device 40. Pressure of the user's back against the massage device 40 is created by the weight of the user 42.

Specifically, FIG. 4A illustrates schematically a location of the massage device with respect to the human body in use when the device 40 is placed in the position 31 in FIG. 3.

FIG. 4B illustrates schematically a location of the massage device 40 with respect to the human body in use when the device is placed in the position 32 in FIG. 3.

FIG. 4C illustrates schematically a location of the massage device with respect to the human body in use when the device 40 is placed in the position 33 in FIG. 3.

FIG. 4D illustrates schematically a location of the massage device 40 with respect to the human body in use when the device is placed in the position 34 in FIG. 3.

FIG. 4E illustrates schematically a location of the massage device with respect to the human body in use when the device 40 is placed in the position 36 in FIG. 3.

In treatment, the user 42 consequently places the device against one of the regions 31-37, and lies down on his back supported jointly by the supporting surface 41 and the device 40. A treatment of each predetermined region with the device of the present invention may be carried out for 3-5 minutes in the regions 31-37 in a desired order, depending upon the particular condition causing the disorder and its severity. As described above, the temperature and amount of the fluid filled in the hollow body of the device can be controlled so that a user (patient) may benefit from the desired massage.

Moreover, if during treatment the user reveals a certain zone of pain or discomfort in his body, the massage device can be placed for 3-5 minutes in this zone.

When desired, the user 42 can do a variety of exercises which increase and vary the pressure against the massage device 40. For example, the pressure may be increased by the user raising one or both legs to a vertical position from horizontal. Moreover, the pressure may be varied when the user makes slight contorting, twisting and/or rolling movements.

In practice, because of the precise nature of the treatment, special instructions can be given to the individual including guided images that will facilitate the usage of the massage device. During the treatment of each region on the back, the user can be instructed to consciously relax the muscles of the back and to reach deep and slow respiration for facilitating the therapeutic effect of the treatment. The user can also be instructed to drink a glass of water (preferably hot water) before and after the whole procedure.

For proper support and for positioning the massage device of the present invention in a variety of positions in relation to the back of the user 42, the area of the support surface 41 can be at least as large as, and shaped to coincide with, the area of the user's back from the buttocks to the shoulders.

According to an embodiment of the invention, the supporting surface 41 is a floor.

According to another embodiment of the invention, the supporting surface is a specially provided board of dimensions sufficient for accommodation of the back of a typical adult human. The board can be made of a flexible or rigid material, and can be placed on a rigid floor to be horizontal. It should be noted that when desired, the board can itself be made of a rigid material to be placed vertically or in a slanted position.

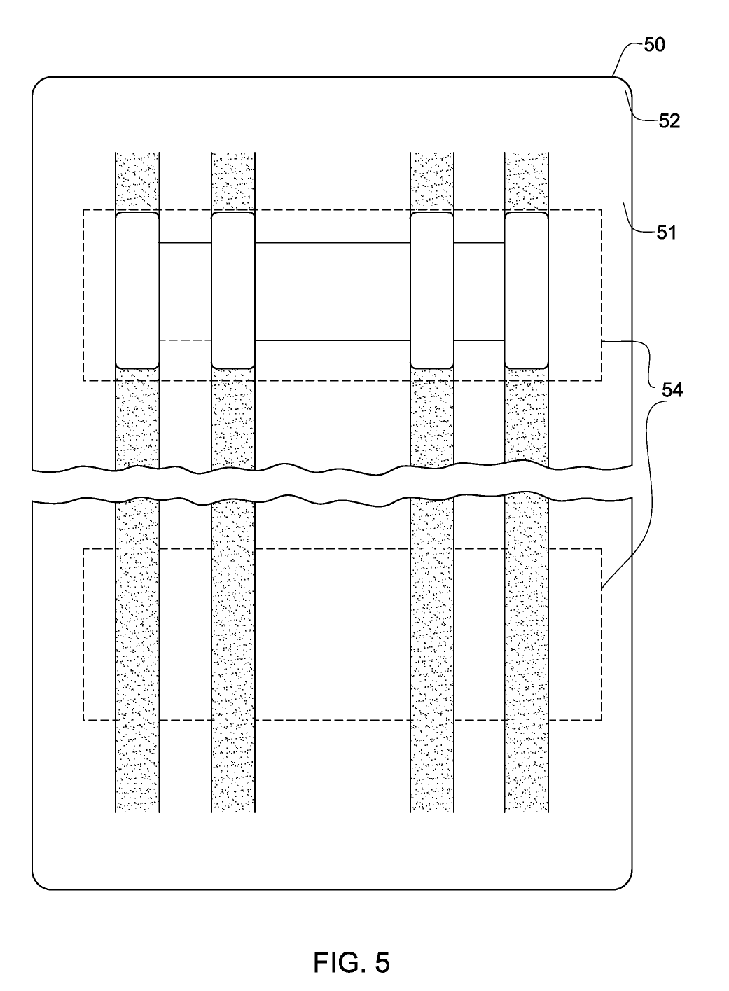

FIG. 5 illustrates a partially broken top view of a supporting surface 50 in the form of a fabric mat or a rigid board for use with a massage device 51 (when the device is configured as shown in FIGS. 1 and 9), in accordance with one embodiment of the present invention. The support surface 50 has dimensions sufficient for accommodation of the back of a typical adult human from buttocks to shoulders. The mat or board 50 comprises a planar under-surface (not shown) to be supported on a flat surface (e.g., floor) (not shown), and an outer surface 52. The outer surface 52 includes guiding elements 53 configured for directional rolling the massage device along the outer surface 52. When desired, the supporting surface 50 can further include a chart 54 of the strategic regions marked on the outer surface 52. The strategic regions correspond to the predetermined regions (31-37 in FIG. 3) of the user's back (not shown) at which the massage device 51 must be positioned for treating the particular medical problem of the user.

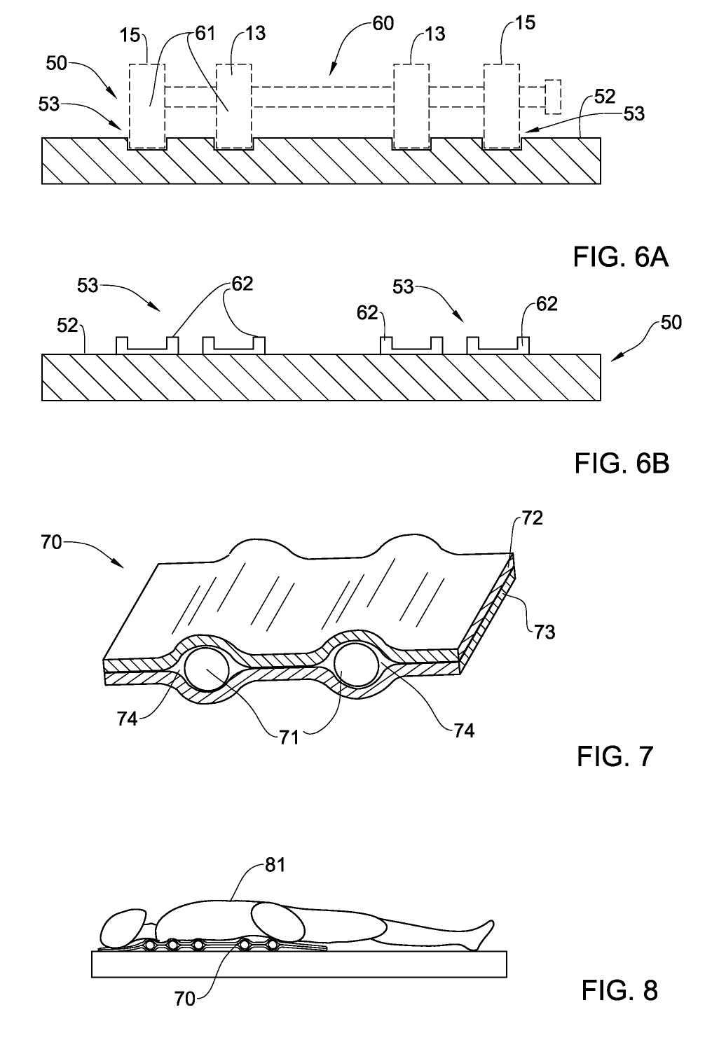

Referring to FIGS. 6A and 6B, schematic side views of the supporting surface (50 in FIG. 5) are illustrated showing the guiding elements 53, according to two different embodiments of the invention. According to the embodiment shown in FIG. 6A, the guiding elements 53 are in the form of four grooves 61 arranged in the outer surface 52. The grooves 61 have dimensions and are adapted for rolling the projecting portions 13 and 15 of a device 60 within the grooves 61 and along the outer surface 52. According to the embodiment shown in FIG. 6A, the guiding elements 53 can include special rails 62 arranged on the outer surface 52 and configured for rolling the projecting portions of the device (not shown) along the outer surface 52.

Referring to FIG. 7, a partial plan view of a supporting surface 70 for use with one or more massage devices 71 of the present invention is illustrated, in accordance with another embodiment of the present invention. The supporting surface 70 represents a mat on which a user can lie for physiotherapeutic treatment. The mat 70 includes two panels 72 and 73 of an elastic material having dimensions sufficient for accommodation of the back of a typical adult human from buttocks to shoulders. The panels 72 and 73 are bound together in such a manner that openings 74 are formed between the panels for inserting massage devices at strategic places which correspond to the predetermined regions (31-37 in FIG. 3) of the user's back, when the user 81 lies on the mat 70, as shown in FIG. 8. It should be understood that the number of the openings 74 in which the massage devices 71 are inserted, and the combination of the predetermined regions (31-37 in FIG. 3) of the user's back used for treatment can be varied depending on the particular medical problem of the user.

According to one embodiment of the present invention, the elastic material of the panels 72 and 73 is made of a fabric material.

According to another embodiment of the present invention, the elastic material of the panels 72 and 73 is made of a plastic material (e.g., polyethylene, polypropylene, etc.).

The panels 72 and 73 can be bound together by various known methods. For example, the panels 72 and 73 can be bound together by sewing. Likewise, for bounding together, facing surfaces (not shown) of the panels 72 and 73 can include hook-type fastening material, such as VELCRO™ material.

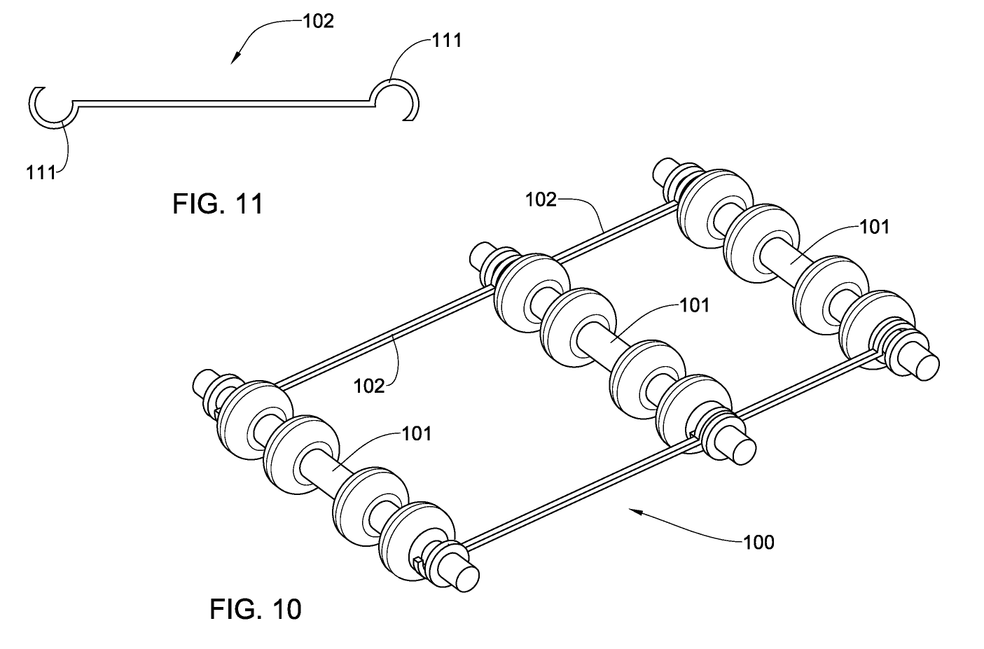

Referring to FIG. 10, a planar view of a supporting arrangement 100 for use with two or more massage devices 101 of the present invention is illustrated, in accordance with still another embodiment of the present invention. In this case, the massage devices 101 are arranged in parallel relationship with respect to each other, and are separated by one or more spacer elements 102 at predetermined distances from each other. By this arrangement, the massage devices 101 can be pressed against the user's back at strategic places which correspond to the predetermined regions (31-37 in FIG. 3), when the user lies on the supporting arrangement 100, similar to the embodiment shown in FIG. 8. The spacer elements 102 can, for example, be in the form of elongated hard brackets or braces (see FIG. 11) having hooks 111 at each end for clipping the spacer elements 102 on the outer surface of the massage devices 101, and thereby maintaining the massage devices 101 at predetermined distances from each other.

As such, those skilled in the art to which the present invention pertains, can appreciate that while the present invention has been described in terms of preferred embodiments, the conception, upon which this disclosure is based, may readily be utilized as a basis for the designing of other structures systems and processes for carrying out the several purposes of the present invention.

For example, when desired, various attachments, bushings and/or sleeves can be placed on the outer surface of the hollow body (11 in FIGS. 1 and 9; and 21 in FIG. 2). Such attachments, bushings and sleeves can include pieces and strips of magnets and metals (e.g., gold, silver, copper), and/or stones (e.g., gem stones, amber) as well as other components for which a favorable influence on the human organism is known when such elements are placed in contact with the surface of the human body.

It is apparent that although only a circular cross-sectional shape of the hollow body 11 is shown in FIG. 1, it should be appreciated that the cross-sectional shape of the hollow body 11 can have an oval cross-sectional shape. Likewise, the cross-sectional shape of the hollow body 21 in FIG. 2 can have semi-oval shape.

An adaptation of the configuration of the massage device of this invention enables it to be used to treat other functional regions of the body, such as the hips, legs and feet; shoulders, arms and hands; neck, thorax and abdomen.

It should be understood that, when desired, the physiotherapeutic treatment of a patient by using the massage device of the present invention can be carried out by an operator. In this case, the patient is simply placed on his or her stomach, and the therapist or other operator presses the device of the present invention against the patient's back at the regions 31-37, as illustrated in FIG. 3. In this case, the total pressure applied to the patient is determined by the amount of force applied by the operator.

It is to be understood that the phraseology and terminology employed herein are for the purpose of description and should not be regarded as limiting.

It is important, therefore, that the scope of the invention is not construed as being limited by the illustrative embodiments set forth herein. Other variations are possible within the scope of the present invention as defined in the appended claims.

What is claimed is:

1. A method for stimulating active points located on a back of a user, comprising:
(a) providing a massage device comprising a hollow body allowing elastic deformations of the walls of said hollow body under applied pressure when said hollow body is pressed against the user's back; wherein said hollow body comprising:
a first pair of projecting portions connected by a central portion having less cross-sectional dimension than the cross-sectional dimension of the projecting portions, the projecting portions of said first pair of projecting portions being spaced apart from each other by a distance substantially equal to the distance separating the first line of the bladder meridian located on the left side of the human body and the first line of the bladder meridian located on the right side of the human body, the projecting portions of said first pair having axial dimension in the range of one to two dimensions of the active point;
a second pair of projecting portions, each being disposed symmetrically with respect to the center of the central portion and extended axially outwardly from a respective one of said first pair of projecting portions, said second pair of projecting portions being spaced by a distance substantially equal to the distance separating the second line of the bladder meridian located on the left side of the human's back and the second line of the bladder meridian located on the right side of the human's back, the projecting portions of said second pair having axial dimension in the range of one to two dimensions of the active point; and
a neck portion being axially extended outwardly from one projecting portion of said second pair, said neck portion having an opening through which a fluid can flow for filling and emptying said hollow body.
(b) filling said hollow body with a hot fluid in the amount sufficient to provide required elastic deformations of the walls of said hollow body under applied pressure when said hollow body is pressed against the user's back, and sealing said hollow body;
(c) pressing said massage device against said user's back such that said first pair of projecting portions and said second pair of projecting portions are applied to at least one predetermined region on the first and second lines of the bladder meridian.

2. The method of claim 1, wherein said filling of the hollow body with a hot fluid is carried out to the fluid amount greater than 50% of a volume of the hollow body, but less than 100% of the volume.

3. The method of claim 1, wherein a temperature of said hot fluid is in the range of 50° C. to 70° C.

4. The method of claim 1, wherein said least one predetermined region on the first and second lines of the bladder meridian is selected from the group including:
a region located in the sacral region, at the level of the second, third and fourth posterior sacral foramina and including active points V28, V29, V32, V33, V34, V53 and V54; thereby treating at least one disorder selected from urinary problems, male deficiency related sexual problems, female sexual and reproductive disorders, low back pain;
a region located on the lower back near the sacroiliac joint of a human, at the level of the spinous process of the fourth and fifth lumbar vertebrae, and including active points V25 and V26; thereby treating at least one disorder selected from back pain problems, disorders related to constipation and menstruation;
a region located on the lower back, at the level of the spinous process of the first and second lumbar vertebrae, and including active points V22, V23, V51 and V52; thereby treating at least one disorder selected from disorders of internal organs selected from liver, spleen, spleen-pancreas, stomach, small and large intestine;
a region located on the upper back, at the level of the spinous process of the fifth and sixth thoracic vertebrae, and including the active points V15, V16, V44 and V45; thereby treating at least one disorder selected from cardiac and lung disorders, problems with respiration, a requirement to invigorate blood;
a region located on the upper back, at the level of the spinous process of the seventh cervical and first thoracic vertebra, and includes active point V11 and VG14; thereby treating at least one disorder selected from problems associated with shoulder, elbow and wrist joints, hand muscles and tendons, cardiac and lung disorders;
a region located on the neck, at the level of the second and third cervical vertebrae; thereby treating at least one disorder selected from problems associated with the gullet, pharynx and thyroid gland; and
a region located in the nuchal region, at the level of the first and second cervical vertebrae, and including active point V10; thereby treating at least one disorder selected from disorders of eyes, ears and nose.

5. The method of claim 1, wherein said pressing of the massage device against said user's back includes:
providing a supporting surface;
associating said massage device with the supporting surface;
positioning the user supine to press the back against the massage device; and
treating said at least one predetermined region with the device for 3-5 minutes.
said hollow body has a substantially circular cross-section.

6. The method of claim 5, wherein said supporting surface comprises a mat or board having dimensions sufficient for accommodation of the back of a typical adult human recumbent thereon, said mat or board comprising a planar under-surface to be supported on a flat surface; and an outer surface including guiding elements configured for directional rolling said massage device along said outer surface.

7. The method of claim 6, wherein said guiding elements include rails arranged on the outer surface and configured for rolling the projecting portions therealong.

8. The method of claim 5, wherein the supporting surface comprises a mat including two panels of an elastic material and having dimensions sufficient for accommodation of the back of a typical adult human recumbent thereon, said two panels being bound together in such a manner that openings are formed for inserting said massage devices between the panels at the places which correspond to the predetermined regions of the user's back when the user lies on the mat.

9. The method of claim 1, further comprising varying a pressure of the user against the massage devise by at least one of the following actions: raising at least one leg by the user to vertical position from horizontal; making by the user contorting and twisting movements.

10. The method of claim 1, further comprising providing the user with special instructions and guided images, thereby facilitating the usage of the massage device.

11. The method of claim 1, further comprising instructing the user to consciously relax the muscles of the back and to reach deep and slow respiration, thereby facilitating the therapeutic effect of the treatment.

12. The method of claim 1, further comprising drinking by the user a glass of water before and after the treatment procedure.

13. A massage device for stimulating active points located on a back of a human, the device comprising a hollow body allowing elastic deformations of the walls of said hollow body under applied pressure when said hollow body is pressed against the human's back; wherein said hollow body comprising:
a first pair of projecting portions connected by a central portion having less cross-sectional dimension than the cross-sectional dimension of the projecting portions, the projecting portions of said first pair of projecting portions being spaced apart from each other by a distance substantially equal to the distance separating the first line of the bladder meridian located on the left side of the human body and the first line of the bladder meridian located on the right side of the human body, the projecting portions of said first pair having axial dimension in the range of one to two dimensions of the active point;
a second pair of projecting portions, each being disposed symmetrically with respect to the center of the central portion and extended axially outwardly from a respective one of said first pair of projecting portions, said second pair of projecting portions being spaced by a distance substantially equal to the distance separating the second line of the bladder meridian located on the left side of the human's back and the second line of the bladder meridian located on the right side of the human's back, the projecting portions of said second pair having axial dimension in the range of one to two dimensions of the active point;
a neck portion being axially extended outwardly from one projecting portion of said second pair, said neck portion having an opening through which a fluid can flow for filling and emptying said hollow body.

14. The massage device of claim 10, wherein said hollow body has a substantially circular cross-section.

15. The massage device of claim 1, wherein said axial dimension of the projecting portions of said first pair and said second pair is in the range of 2 cm to 3 cm.

16. The massage device of claim 1, wherein said hollow body is made of a polymer material selected from polyethylene, polypropylene, polyethylene terephthalate, and polyamides.

17. The massage device of claim 1, wherein said hollow body has a substantially semicircular cross-section.

18. The massage device of claim 1, wherein said hollow body is filled with a filler material, said filler material including at least one material selected from a granular material, free-flowing dry material and fluid.

19. The massage device of claim 14, wherein said filler material has a temperature in the range of about 50° C. to about 70° C.

20. The massage device of claim 14, wherein an amount of the filler material filling said hollow body is in the range of about 50% to about 100% of the volume of the hollow body.
